(19) United States
(12) Patent Application Publication
(10) Pub. No.: US 2007/0153740 A1
(43) Pub. Date: Jul. 5, 2007

(54) Method and apparatus for media handover in the network

(75) Inventors: Cheng-Yue Chang, Gongguan Township (TW); Jeng-Chun Chen, Taipei City (TW); Chi-Fan Ho, Taipei City (TW); Meng-Cheng Chen, Taipei City (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Arcadyan Technology Corporation

(21) Appl. No.: 11/325,582

(22) Filed: Jan. 4, 2006

(51) Int. Cl. H04Q 7/00

(52) U.S. Cl. 370/331; 370/338

(57) ABSTRACT

An innovative apparatus and method for media handover in the network is proposed. The apparatus comprises a communication network; a data source provider and handover devices. The handover device comprises a handover module for executing the handover execution. The handover process comprises searching for handover target devices by a searching protocol in a communication network, wherein the communication network comprises a wireless communication network or a wired communication network; selecting the target device and starting a handover process; querying the operation mode of the target device; and performing the handover process.

### FIELD OF THE INVENTION

The invention relates to a network controlling device, and more specifically, to a method and apparatus for allowing a user to save, recall, and transfer both media playback and device setting states between the network devices.

### BACKGROUND OF THE INVENTION

### Description of the Prior Art

In digital networks in these days, widespread use has been made of a network handling radio signal transmission media such as a mobile radio network, in addition to the conventional cable network using metallic conductors or optical fibers. In connection with the mobile radio network as above, there are available the existing STM (synchronous transfer mode) network as described in “Mobile Communication System” published by Ohm-sha, a PDC (personal digital cellular) or PHS (personal handyphone system) radio network described in “Easy Digital Exchange” published by Denki Tsushin Kyokai in which signals carried on time slots are communicated like the time-division network for communicating signals carried on time-shared time slots within a synchronized frame, or a CDMA (code division multiple access) radio network. Handling of the above-mentioned signal process is sometimes required to be changed depending on differences in media and the mutual relation to other networks. Exemplarily, some of the signal process specific to mobile targets need the error correction coding process but on the other hand, in some applications, it is preferable that the coding process as above is not carried out from the standpoint of connection to the existing networks.

Video streaming, data streaming, and broadband digital broadcast programming are increasing in popularity in wireless network applications. As such, wireless data packets may be sent to multiple receivers (e.g. network enabled mobile devices) at the same time, which is referred to as multicasting or data casting. Currently, systems such as WLAN, digital video broadcast (DVB) systems and digital audio broadcast (DAB) systems can be used to transfer multicast data. In the future, UMTS or GPRS networks may also have the capability of supporting IP multicasting.

Moreover, one area associated with wireless communications relates to a handoff or handover process. Generally a handover process refers to a scenario in which a mobile network passes a wireless communication from one cell to another cell. A handover is generally a response to geographic movement by a mobile station from one cell to another. Two elements are generally involved in a handover: handover decision, and handover execution. The handover execution transition should be relatively seamless, providing no disruption to a communication and maintaining a high standard of call quality.

Furthermore, we can suspend and resume a media playback state for a media player device. However, if the user desires to save a media state (such as the playback state of a movie, song or music playlist, or a particular television show) and associated device settings from one home device, and later recall, or transfer the saved media and device states to a different home device, it would involve significant time and many laborious steps to be performed by the user.

In view of the aforementioned, the present invention disclose a new apparatus and method for a media handover in the network for allowing a user to save, recall, and transfer both media playback and network devices setting states conveniently.

### SUMMARY OF THE INVENTION

The main object of the present invention is to disclose an apparatus and method for media handover in a communication network.

The invention is to provide a method of handover media contents seamlessly to different devices in the networks. The method can be applied in the system comprised of devices connected in the networks, with media sources such as IP streaming from servers in the local area network or internet, conventional broadcasting, and contents stored in the devices.

This invention relates a method and apparatus of handover current playback media content in one media device to another media device in the network environment. It provides the experience of sharing media seamlessly within the network environment especially with family and friends.

This invention allows users to handover the media playback from one network device to another network device easily with just one button control. It allows user to suspend easily the media playback in the network device (A) and to resume the media playback in another network device ( B ) . And, the suspending and resuming command could be done in networked device A or B.

The present invention can be applied to media receiver (or DMA) type of device, and the device with media handover capability may connect to a LAN/WLAN.

The further advantages of the apparatus and method for media handover in a communication network of the present invention are media sharing without too much user interference and the media follow-up with simple solution.

One aspect of the present invention is to provide an apparatus for data handover in a communication network comprising: a data source provider for providing data; pluralities of handover devices coupled to the data source through a the communication network for receiving the data, one of the pluralities of handover devices may handover data to another one handover device by a handover command message through the communication network.

In one embodiment, the communication network comprises a wireless communication network or a wired communication network. The data source provider comprises at least one of the pluralities of handover devices, a streaming server or a radio station.

The handover device comprise a processor; a receiver coupled to the processor for receiving the data; a transceiver coupled to the processor for transmitting the data; a tuning circuit coupled to the processor; operating system ( OS ) coupled to the processor; a memory coupled to the processor; a local area network (LAN) module coupled to the processor; a wireless local area network (WLAN) module coupled to the processor; and a handover module coupled to the processor for executing handover execution.

A further aspect of the invention is to provide a method for data handover in a communication network, comprising: searching for handover target devices by a searching protocol through a communication network, wherein the communication network comprises a wireless communication network or a wired communication network; selecting the target device and starting a handover process; querying the operation mode of the target device; and performing the handover process.

The step of starting a handover process comprises performing receiving and recognizing a handover command message.

The step of performing handover process comprises the following steps: retrieving a current channel frequency of a radio station from the target device; tuning the frequency received from the data source; and performing a cease procedure to terminate communicating action, in responsive to the cease procedure by ending the transmission of the target device.

The step of performing handover process comprises the following steps: retrieving the internet radio station URL ( Uniform Resource Locator) of a internet radio server from the target device; requesting streaming from the URL; and performing a cease procedure at the target device to terminate the communicating action, in responsive to the cease procedure by ending the transmission of the target device.

The step of performing handover process comprises the following steps: retrieving the URL (Uniform Resource Locator) and the streaming offset of a remote file of a media server from the target device; requesting streaming of the remote file from the URL; and performing a cease procedure at the target device to stop communicating action, in responding to the cease procedure by ending the transmission of the target device.

The step of performing handover process comprises the following steps: retrieving the URL (Uniform Resource Locator) and the playback offset of the local file from the target device; requesting streaming of the local file from the URL; and performing a cease procedure at the target device to stop communicating action, in responding to the cease procedure by ending the operation of the target device.

### BRIEF DESCRIPTION OF THE DRAWINGS

For a better understanding of the present invention and to show how it may be carried into effect, reference will now be made to the following drawings, which show the preferred embodiments of the present invention, in which:

FIG. 1 shows a system for media handover in a communication network according to an embodiment of the present invention.

FIG. 2A˜2C shows a system for media handover of a radio listening according to a preferred embodiment of the present invention.

FIG. 3 shows a flow chart of method for media handover according to the present invention.

FIG. 4A˜4C shows a system for media handover of an internet radio listening according to another preferred embodiment of the present invention.

FIG. 5A˜5C shows a system for media handover of remote file streaming according to the other preferred embodiment of the present invention.

FIG. 6A˜6C shows a system for media handover of local file playback according to yet another preferred embodiment of the present invention.

FIG. 7 shows a functional block diagram of an example handover device according to the present invention.

### DESCRIPTION OF THE PREFERRED EMBODIMENTS

The present invention discloses an apparatus and method for a media handover through or in the network system. In the following description, numerous specific details are set forth in order to provide a thorough understanding of the present invention, and the scope of the present invention is expressly not limited expect as specified in the accompanying claims. One skilled in the relevant art will recognize, however, that the invention may be practiced without one or more of the specific details. In other instances, well known structures, materials, or operations are not shown or described in order to avoid obscuring aspects of the invention.

Those of ordinary skill in the art will immediately realize that the embodiments of the present invention described herein in the context of methods and schematics are illustrative only and are not intended to be in any way limiting. Other embodiments of the present invention will readily suggest themselves to such skilled persons having the benefits of this disclosure.

This invention relates to an apparatus and method for a media handover in the network system allowing for a user to save, recall, and transfer both media playback and network devices setting states between network devices.

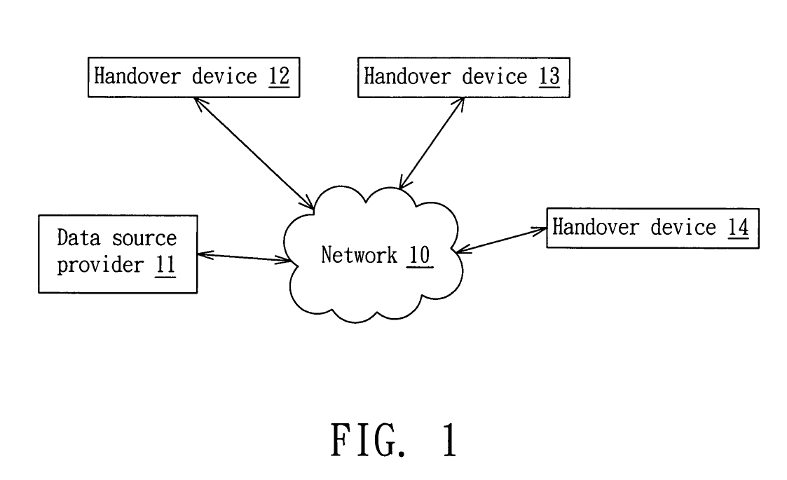

FIG. 1 shows a system for media handover in a communication network 10 according to an embodiment of the invention that for simplicity includes adjacent handover devices 12, 13, 14, and a data source provider 11. The communication network 10 may be for example, a wireless communication network, such as a wireless broadcast network or a system of communication network for IEEE 802.11 a/b/g or IEEE 802.11 n; or a wired communication network, such as an IP network or Ethernet. However, a higher bandwidth network is preferred, such as a network including a terrestrial Digital Video Broadcast system (DVB-T), a Digital Audio Broadcast system (DAB), a Global Packet Radio Service (GPRS), a Voice over Internet Protocol (VOIP) network, or a network that combines more than one of these broadcast systems. Each handover devices 12, 13, 14 generally includes a handover module with abilities for executing handover execution of media information such as a video streaming, data streaming, or broadband digital broadcast programming multicast signals on a different frequency (or alternatively with a different code as appropriate) for each handover device through the network 10. The data source provider 11 may provide media sources such as IP streaming from servers in the local area network or internet, conventional broadcasting or above-mentioned network system, and contents stored in the handover devices. In one embodiment, the data source provider 11 may comprise handover device, streaming server or base station. In other words, in the condition of the handover device as the data source provider, the handover device 12, 13, 14 may be substantially synchronizing handover the media including video streaming, data streaming, or broadband digital broadcast programming multicast signals with each other by utilizing requesting a command for the media provider such as handover device 12 and controlling the handover module of the handover device 12, 13, 14 through the network 10. Moreover, the handover device 12, 13, 14 may be substantially synchronizing handover the media including video streaming, data streaming, or broadband digital broadcast programming multicast signals with each other by utilizing requesting a command for the data source provider 11 such as streaming server or base station and controlling the handover module of the handover device 12, 13, 14 through the network 10.

Accordingly, the handover device 12 may handover the media playback to another handover device 13, 14 easily with just requesting a command for the handover device 12. It allows user to suspend easily the media playback in the handover device 12 and to resume the media playback in another handover device 13, 14. Further, the suspending and resuming command could be done in the handover devices 12, 13 or 14.

In one embodiment, two or more media devices with media handover capability such as the handover devices 12, 13 or 14 are connected to the same network. Every handover device provides the handover service, which keeps track of the current operation and its parameters of the handover device and sends these parameters to other handover devices on requests. For example, such operation parameters comprise current channel frequency of (FM/AM) radio, radio station URL (Uniform Resource Locator) of internet radio server, file URL and byte offset of remote ( such as media server) file streaming, and file path and byte offset of local ( handover devices) file playback. Alternatively, each device optionally owns a streaming server to stream local media file to other device in the case of handover of local file playback.

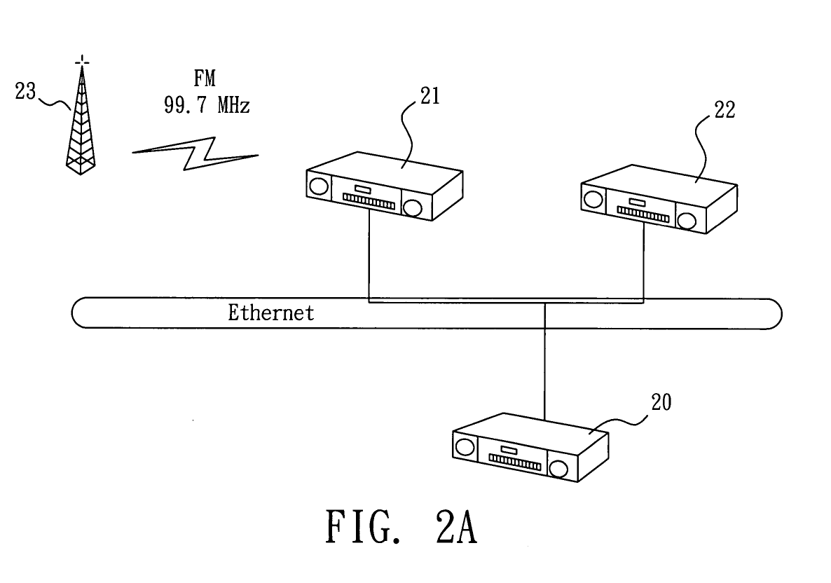

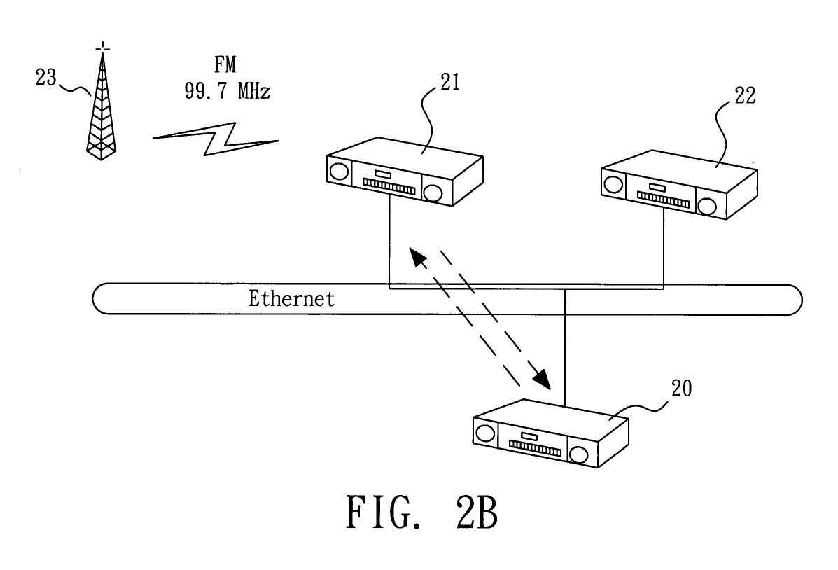

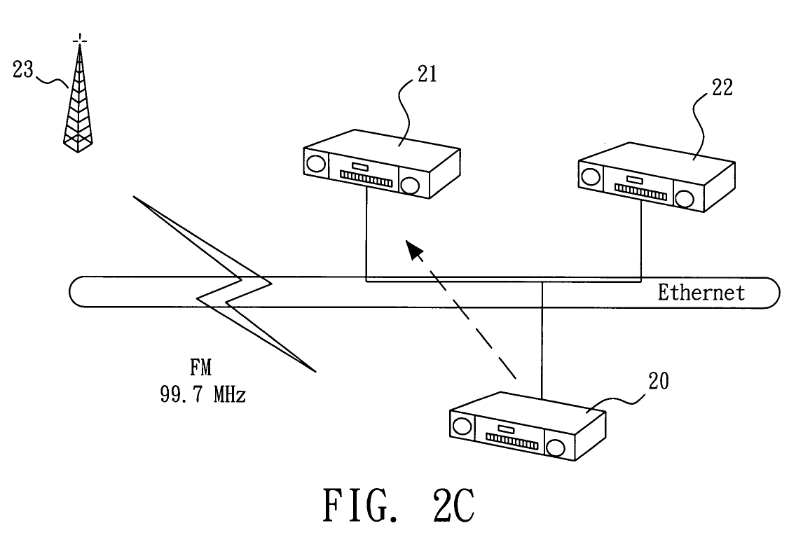

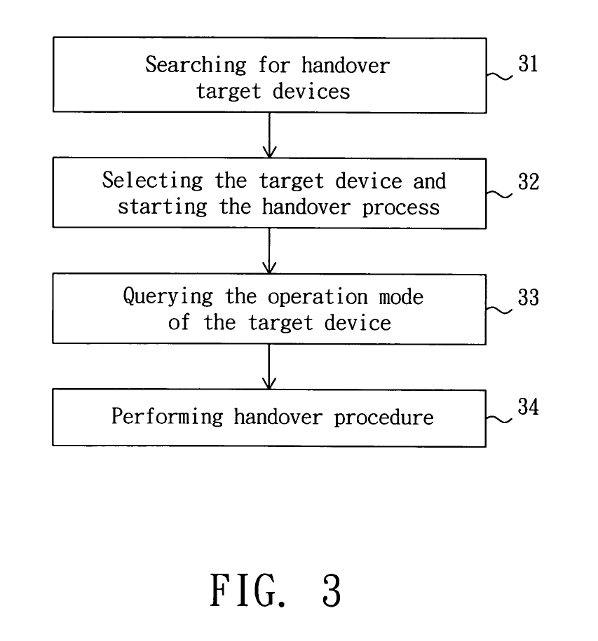

FIG. 2A˜2C shows a system for media handover of radio listening according to a preferred embodiment of the present invention. The system comprises a host device 20, handover devices 21, 22 and a data source such as a radio station 23 for transmitting and receiving the communication message between the handover device and the data source. The handover devices 21, 22 handover radio data with the host device 20 through the Ethernet. The radio station 23 is an audio signal source provider. The media handover process flow show in FIG. 3. Firstly, a step 31 of searching for handover target devices such as handover device 21 is performed, shown in FIG. 2A. For example, the searching step can be achieved by any existing searching mechanism/protocol such as an UPnP (Universal Plug and Play) . The handover target device receives a radio signal from the radio station 23. The handover target devices can provide the handover service by utilizing such as handover module or handover programs/software. Subsequently, a step 32 of selecting the target device of handover device 21 and starting the handover process is executed, shown in FIG. 2B. In the meanwhile, receiving and recognizing a handover command message at the host device 20 and handover device 21 is performed to initiate a handover execution. Subsequently, next step 33 is to query the operation mode of the target device 21 by the host device 20. Similarly, the host device also can provide the handover service by utilizing such as handover module having handover programs/software. For different operation mode of the target device, a specific step 34 will be enforced for performing handover procedure. In this embodiment, the handover process performs the first step of retrieving the current channel frequency from the target device 21. Next, a step of tuning the frequency received from the (FM/AM) radio station 23 is performed. Finally, a step of stopping the current operation of the target device 21 and completing handover procedure of the host device 20 from the target device 21 is executed. In the meanwhile, receiving a cease signal at the target device 21 to stop communicating action is performed, shown in FIG. 2C.

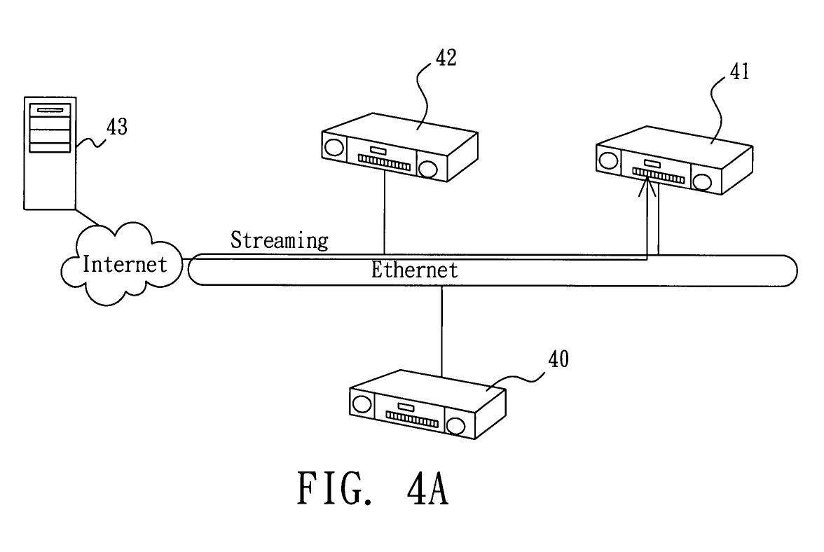

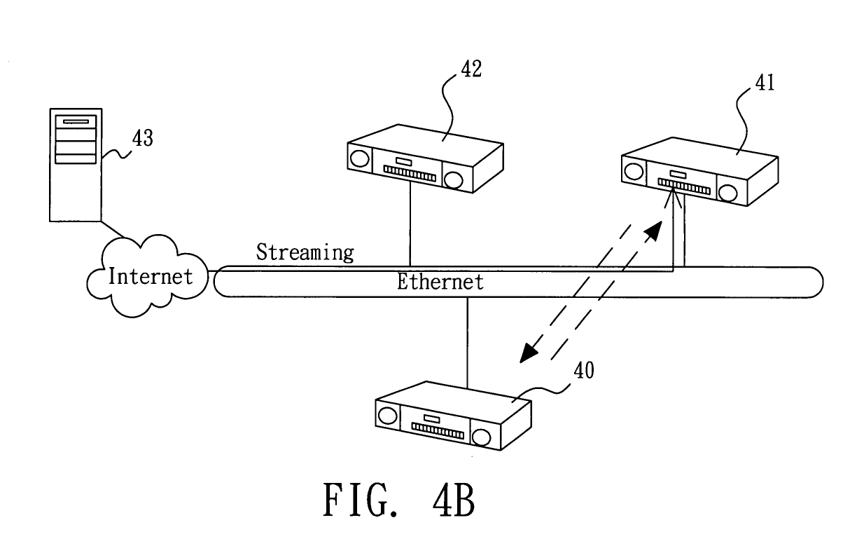

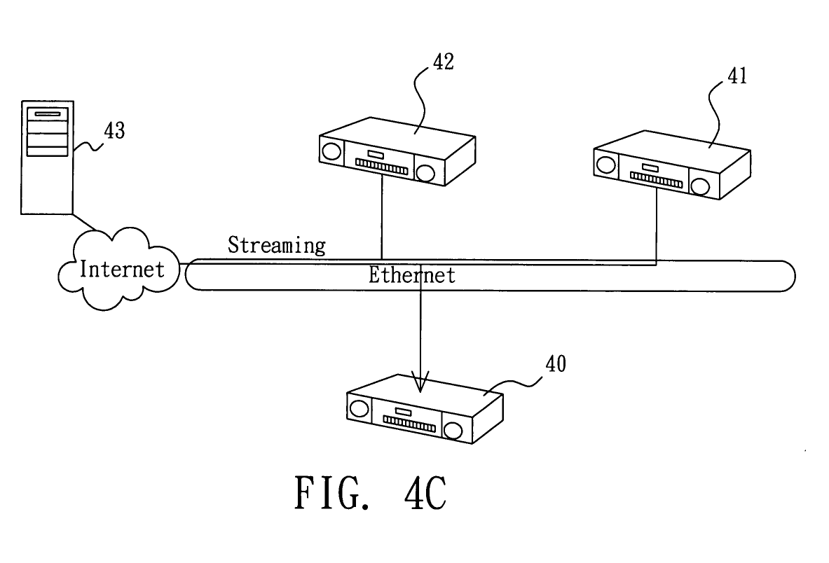

FIG. 4A˜4C shows a system for media handover of an intemet radio listening according to another preferred embodiment of the present invention. The system comprises a host device 40, handover devices 41, 42 and an internet radio server 43. The internet radio server 43 is an audio signal source provider (data source). The handover target device receives a radio streaming data from the internet radio server 43 through the internet. The handover devices 41, 42 will handover the radio streaming data with the host device 40 through the internet. The handover process of the internet radio listening is shown in FIG. 3. Firstly, a step 31 of searching for handover target devices such as handover device 41 is performed, shown in FIG. 4A. For example, the searching step can be achieved by any existing searching mechanism/protocol such as an UPnP (Universal Plug and Play) . The handover target devices can provide the handover service by utilizing handover module or handover programs/software. Subsequently, a step 32 of selecting the target device of handover device 41 and starting the handover process is executed, shown in FIG. 4B. In the meanwhile, the next step is to receive and recognize a handover command message at the host device 40 and handover device 41 to initiate a handover execution. And then, a step 33 of querying the operation mode of the target device 41 by the host device 40 is executed. Similarly, for different operation mode of the target device, a specific step 34 of performing handover procedure is enforced. In this embodiment, the handover process is firstly retrieving the internet radio station URL of the internet radio server 43 from the target device 41. Next, a step of request streaming from the URL is performed. Finally, the subsequent step is to stop the current operation of the target device 41 and complete handover procedure of the host device 40 from the target device 41. In the meanwhile, the target device 41 receives a cease signal to terminate the communicating action. The internet radio server 43 is then responsive to the cease signal by ending the transmission of the target device 41, shown in FIG. 4C.

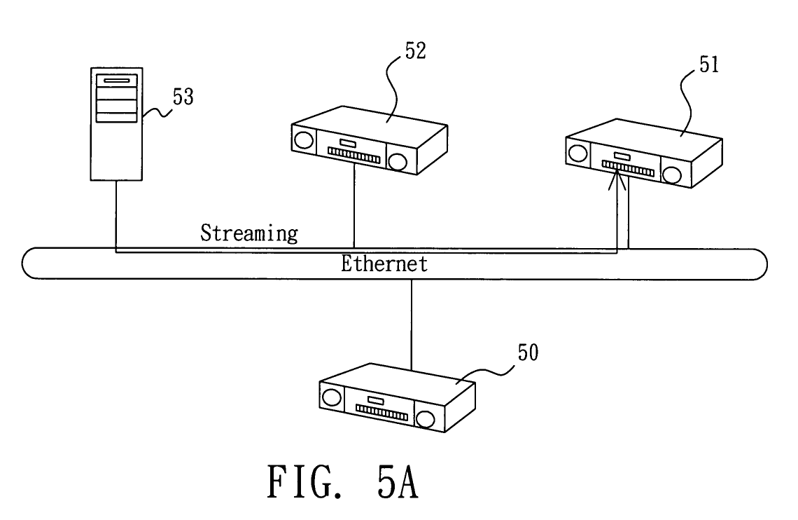

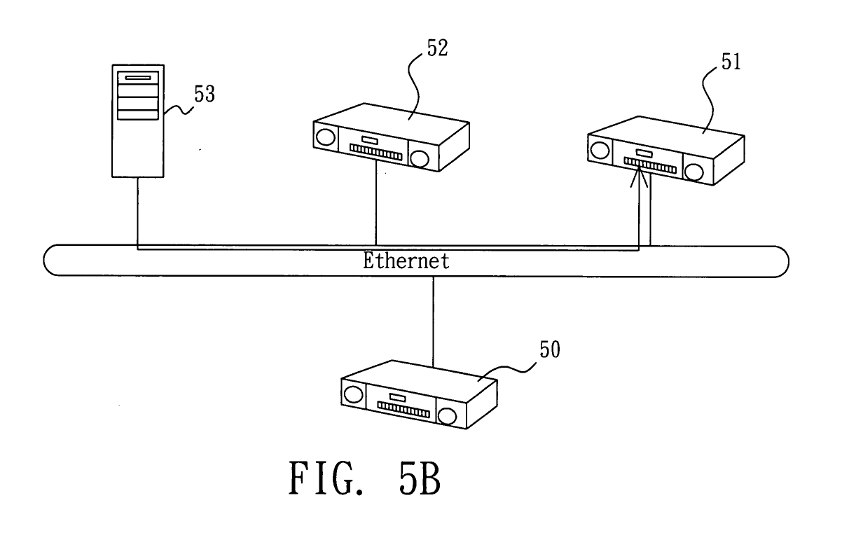

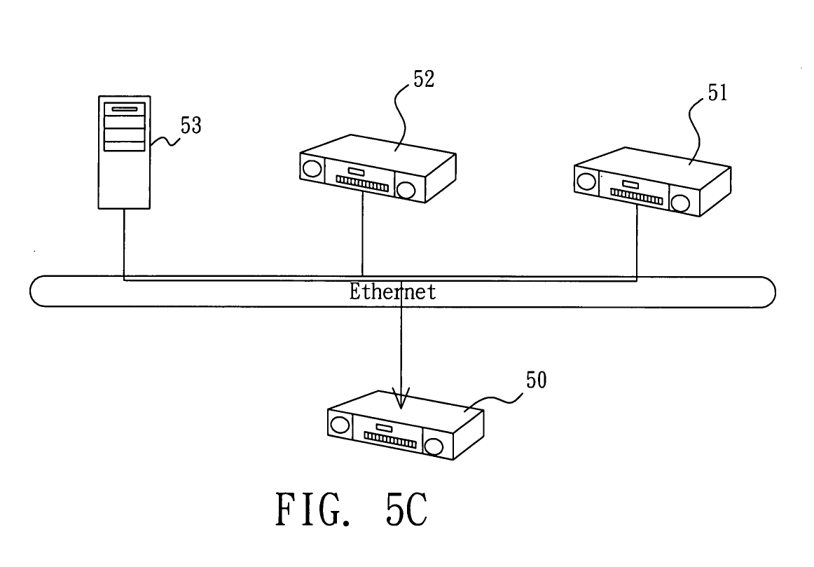

FIG. 5A˜5C shows a system for media handover of remote file streaming according to the other preferred embodiment of the present invention. The system comprises a host device 50, handover devices 51, 52 and a media server 53. The media server 53 is a data source provider. The handover target device receives a streaming data from the media server 53 through the internet. The handover devices 51, 52 handover the streaming data with the host device 50 through the internet. The handover process of the remote file streaming shows in FIG. 3. Firstly, a step 31 of searching for handover target devices such as handover device 51 is performed, shown in FIG. 5A. For example, the searching step can be achieved by any existing searching mechanism/protocol such as an UPnP (Universal Plug and Play) . The handover target devices can provide the handover service by utilizing such as handover module or handover programs/software. Subsequently, a step 32 of selecting the target device of handover device 51 and starting the handover process is executed, shown in FIG. 5B. In the meanwhile, receiving and recognizing a handover command message at the host device 50 and handover device 51 is performed to initiate a handover execution. And then, a step 33 of querying the operation mode of the target device 51 by the host device 50 is executed. Similarly, for different operation mode of the target device, a specific step 34 of performing handover procedure is enforced. In this embodiment, the handover process is firstly retrieving the URL and the streaming offset of the remote file from the target device 51. Next, a step of request streaming of the remote file from the URL with the offset parameter is performed. Finally, a step of stopping the current operation of the target device 51 and completing handover procedure of the host device 50 from the target device 51 is executed. In the meanwhile, receiving a cease signal at the target device 51 to stop communicating action, and the media server 53 responding to the cease signal by ending the transmission of the target device 51 is performed, shown in FIG. 5C.

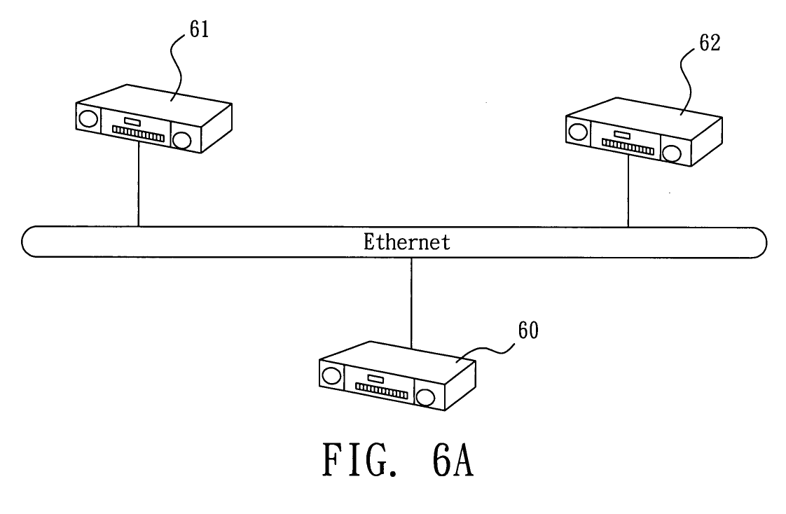

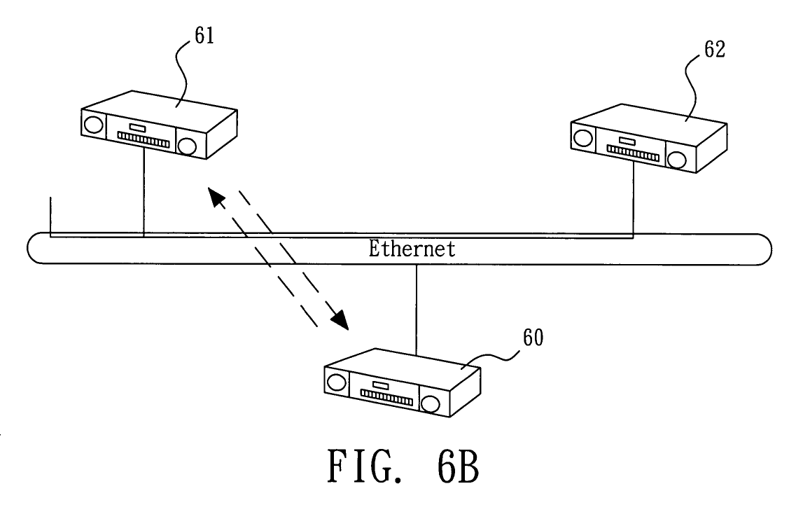

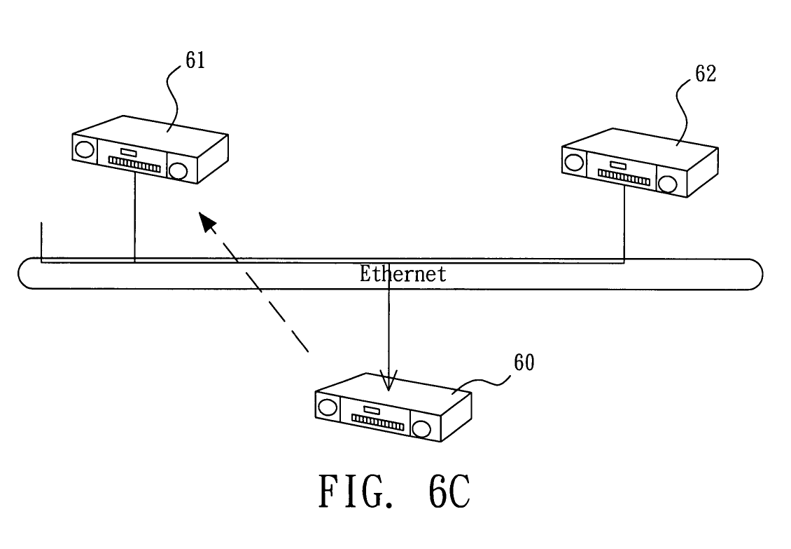

FIG. 6A˜6C shows a system for media handover of local file playback according to yet another preferred embodiment of the present invention. The system comprises a host device 60, handover devices 61, 62. The embodiment is similar to the embodiment of FIG. 5 except the media server 53 is omitted. One of the host devices is used as the data source. Thus, the similar description is omitted.

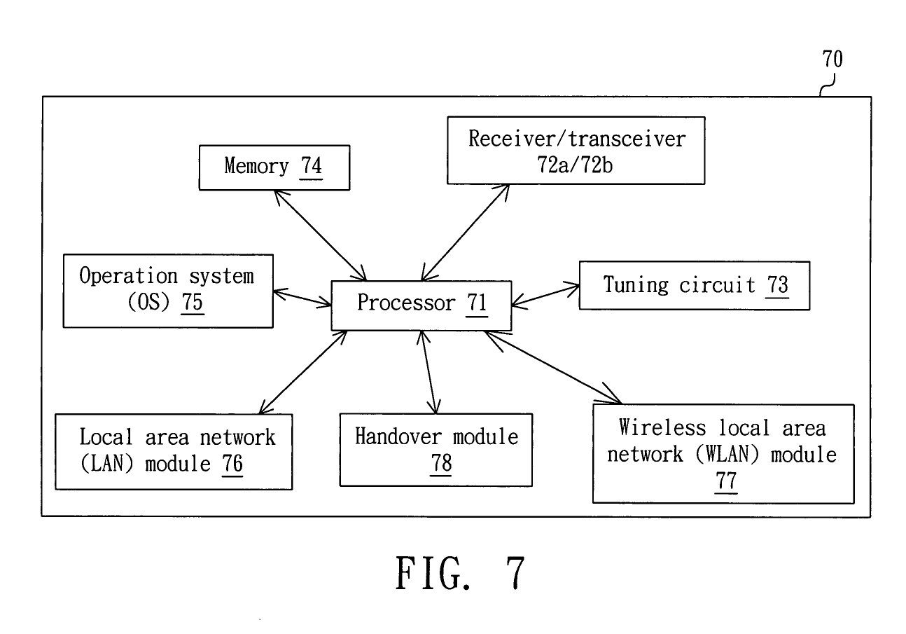

Referring now to FIG. 7, a functional block diagram of an example handover device 70 is shown. Handover device 70 according to one embodiment generally includes a processor 71, receiver/transceiver 72a/72b, tuning circuit (optional) 73, memory 74, operating system (OS) 75, local area network (LAN) module 76, wireless local area network (WLAN) module 77 and handover module 78. Memory 74 may store mapping information such as physical links, associated IP addresses, frequency, etc. For example, the processor 71 may be coupled to the receiver/transceiver 72a/72b, tuning circuit 73, memory 74, operating system ( OS ) 75, local area network (LAN) module 76, wireless local area network (WLAN) module 77 and handover module 78, and in accordance with operating instructions stored in the processor 71, directs operation mode of the handover device 70. Receiver 72a may be used by handover device 70 to wirelessly communicate with a remote controller to receive a transmission signal from the remote controller. Tuning circuit 73 tunes transceiver 72b to a desired channel for a particular broadcasting station in order to receive a particular channel based on the ( internet ) radio. More specifically, tuning circuit 73 may direct transceiver 72 to tune to desired channels of the current broadcasting station.

The local area network (LAN) module 76, wireless local area network (WLAN) module 77 provides the connection to wired or wireless network for receiving desired datagrams, such as IP datagrams associated with desired handover devices. The handover module 78 may provide handover service and alternatively be software, hardware or any other object, component, or element operable to facilitate handover execution in the wired or wireless communications system. It will be appreciated by those of skill in the art that two or more of the above components may be combined into a single component, and that any of the above components or combinations may be performed via hardware, software, or a combination of the two.

In conclusion, the method and apparatus of media handover of the present invention may be allowing for a user to save, recall, and transfer both media playback and device setting states between the network devices.

Although the present invention has been described in detail with reference to particular embodiments illustrated in FIGS. 2˜6, it should be understood that various other changes, substitutions, and alterations may be made hereto without departing from the spirit and scope of the present invention. For example, although the present invention has been described as operating in the preferred embodiments, the present invention may be used in any communications environment where a handoff or a handover is suitable. The handover execution protocol disclosed in the preceding figures is generally applicable to all communication systems in which communication links are transferred from one unit to the next.

Additionally, although the present invention has been described with reference to communications between the handover devices, the protocol described for executing an efficient handover scheme may be implemented between any two components within a network. The present invention has merely described in the preferred embodiments, which is inclusive of these elements that facilitate handover execution, for purposes of teaching the present invention and should not be construed to limit how or where this handover execution protocol is implemented. Moreover, the handover protocol, as disclosed above, may be implemented in any component, unit, hardware, software, object or element involved in the communications process.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. An apparatus for data handover in a communication network, comprising:
a data source for providing data;
pluralities of handover devices coupled to said data source through a communication network for receiving said data, one of said pluralities of handover devices may handover said data to another one handover device by a handover command message through said communication network.

2. The apparatus of claim 1, wherein said communication network comprises a wireless communication network or a wired communication network.

3. The apparatus of claim 1, wherein said data source comprises at least one of said pluralities of handover devices, a streaming server or a radio station.

4. The apparatus of claim 1, wherein said handover device comprise:
a processor;
a receiver coupled to said processor for receiving said data;
a transceiver coupled to said processor for transmitting said data;
a memory coupled to said processor;
a local area network (LAN) module coupled to said processor;
a wireless local area network (WLAN) module coupled to said processor; and
a handover module coupled to said processor for executing handover execution.

5. The apparatus of claim 4, further comprising a tuning circuit coupled to said processor.

6. The apparatus of claim 4, further comprising a operating system (OS ) coupled to said processor.

7. A method for data handover in a communication network, comprising:
searching for handover target devices by a searching protocol through a communication network;
selecting said target device and starting a handover process;
querying the operation mode of said target device; and
performing said handover process.

8. The method of claim 7, wherein said communication network comprises a wireless communication network or a wired communication network.

9. The method of claim 7, wherein said protocol comprises an UPnP (Universal Plug and Play).

10. The method of claim 7, wherein said step of starting a handover process comprises performing receiving and recognizing a handover command message.

11. The method of claim 7, wherein said step of performing said handover process comprises the following steps:
retrieving a current channel frequency of a radio station from said target device; and
performing a cease procedure to terminate communicating action, in responsive to said cease procedure by ending the transmission of said target device.

12. The method of claim 11, further comprising a step of tuning the frequency received from said data source after said retrieving step.

13. The method of claim 7, wherein step of performing said handover process comprises the following steps:
retrieving a internet radio station URL (Uniform Resource Locator) of a internet radio server from said target device; and
performing a cease procedure at said target device to terminate the communicating action, in responsive to said cease procedure by ending the transmission of said target device.

14. The method of claim 13, further comprising a step of requesting streaming from said URL after said retrieving step.

15. The method of claim 7, wherein said step of performing said handover process comprises the following steps:
retrieving a URL ( Uniform Resource Locator) and the streaming offset of a remote file of a media server from said target device; and
performing a cease procedure at said target device to stop communicating action, in responding to said cease procedure by ending the transmission of said target device.

16. The method of claim 15, further comprising a step of requesting streaming of said remote file from said URL after said retrieving step.

17. The method of claim 7, wherein said step of performing said handover process comprises the following steps:
retrieving a URL (Uniform Resource Locator) and the playback offset of the local file from said target device; and
performing a cease procedure at said target device to stop communicating action, in responding to said cease procedure by ending the operation of said target device.

18. The method of claim 17, further comprising a step of requesting streaming of said local file from said URL after said retrieving step.
